(19) United States
(12) Patent Application Publication
(10) Pub. No.: US 2009/0320079 A1
(43) Pub. Date: Dec. 24, 2009

(54) ON-VEHICLE EQUIPMENT FOR RECEIVING AND DISPLAYING DIGITAL BROADCASTING

(75) Inventors: Osamu TOMOBE, Mito (JP); Takaharu ISHIDA, Hitachinaka (JP); Nobuaki EJIMA, Hadano (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/485,310

(22) Filed: Jun. 16, 2009

(30) Foreign Application Priority Data
Jun. 19, 2008 (JP) 2008-160868

(51) Int. Cl. H04N 7/18

(52) U.S. Cl. 725/75

(57) ABSTRACT

An on-vehicle equipment mounted on a vehicle and adapted to receive a data broadcasting transmitted in digital broadcasting and display it on a display unit, holds a contents of the data broadcasting in correspondence with a combination of component tag value and module ID for discriminating the contents, displays, in accordance with layout information of defaults containing information indicative of areas on the screen of display unit at which contents are displayed, a corresponding contents on the screen of the display unit, and acquires, when a combination of component tag value and module ID is received, a contents corresponding to the combination of component tag value and module ID and displays the acquired contents on the screen of display unit in a size larger than that for display pursuant to the default layout information.

### BACKGROUND OF THE INVENTION

The present invention relates to an on-vehicle equipment mounted on a transportation means such as a vehicle and adapted to receive and display a data broadcasting transmitted in digital broadcasting.

The digital broadcasting to be on the air by using 13 segments can transmit high-definition images which are therefore assumed to be displayed on a display unit having a large screen of several tens of inches. Further, in the digital broadcasting, not only images but also data broadcastings are transmitted. Contents in the data broadcasting are often displayed in a partial area of image screen set up through screen separation in the display unit.

Incidentally, in recent years, an on-vehicle equipment has been marketed which is mounted on a transportation object such as vehicle and adapted to receive and display images of the digital broadcast to be on the air by using the 13 segments and besides data broadcastings transmitted in the digital broadcasting as well. This type of on-vehicle equipment is often provided with a compact display unit of several inches. Accordingly, the image of digital broadcast and the contents of data broadcasting are constricted so as to be displayed within a screen area of several inches, thus being sometimes aggravated in visibility.

In the case of the image, it can be watched while interpolating the information to a certain extent with the help of motion and audio signal but the entity of the contents in data broadcasting is often displayed in the form of a character or figure and therefore, if the display per se is hardly visible, the information indicated by the contents cannot sometimes be recognized.

A technique to avoid the problems as above is disclosed in JP-A-2007-13819, according to which templates are prepared in respect of individual environments of the screen on which data broadcastings are displayed and the thus prepared plural templates are transmitted together with a data broadcasting whereas on the receiving side, out of the received plural templates, a template corresponding to a screen environment on the receiving side is specified and each contents is adjusted for its size and position on the screen in accordance with the specified template and then displayed.

### SUMMARY OF THE INVENTION

As the display unit for displaying data broadcastings, however, various types are available including an on-vehicle equipment typified by navigator, a mobile phone and a notebook sized personal computer and so there are numerous screen sizes and numerous combinations of resolution degrees permissible to displaying. Complete preparation for templates corresponding to all of the screen environments will sometimes be laborious, time-consuming and costly. Further, since the transmission band for data in data broadcasting is limited, the data amount of the contents to be transmitted originally will sometimes be limited as the number of templates to be transmitted increases.

The present invention has been made in the light of the circumstances as above and it is an object of the present invention to display contents in the data broadcasting more easily visibly than ever without having an influence upon the data transmission band in data broadcasting.

To solve the aforementioned problems, in an on-vehicle equipment according to the present invention, a drawing component displayed on the screen at a position designated by the user is so processed as to be displayed in an enlarged fashion.

For example, according to an embodiment of the invention, an on-vehicle equipment mounted on a vehicle and adapted to receive a data broadcasting transmitted in digital broadcasting is provided which comprises a contents information holding unit for holding a contents of the data broadcasting in correspondence with a combination of component tag value and module ID for discriminating the contents; a contents information acquisition unit for acquiring a contents transmitted in data broadcasting and for storing in the contents information holding unit the acquired contents together with a corresponding combination of component tag value and module ID; a layout information preparation unit for preparing, in respect of individual combinations of component tag values and module ID's for discriminating the individual contents, layout information of defaults containing information indicative of areas on the screen of the display unit at which the contents are displayed; a contents display unit for acquiring, in accordance with the layout information of defaults, a corresponding contents from the contents information holding unit and displaying it on the screen of the display unit; and a contents information specifying unit for specifying, by consulting the layout information of defaults, a combination of component tag value and module ID corresponding to a contents displayed at a coordinate on the screen of display unit designated by the user and transmitting the specified combination of component tag value and module ID to the contents display unit, wherein when receiving a combination of component tag value and module ID from the contents information specifying unit, the contents display unit acquires, by consulting the contents information holding unit, a contents corresponding to the combination of component tag value and module ID and displays the acquired contents on the screen of the display unit in a size larger than that for display pursuant to the layout information of defaults.

An on-vehicle equipment according an embodiment of the present invention can display contents in a data broadcasting more easily visibly than ever without having an influence upon the data transmission band in data broadcasting.

An on-vehicle equipment according to another embodiment of the invention can display a contents designated by the user by automatically enlarging it on the ensuing occasions.

An on-vehicle equipment according to still another embodiment of the invention ties a contents the user designates with an active event at the time of designation by the user so that even the same contents may be displayed in an enlarged fashion at the timing meeting the request the user makes.

An on-vehicle equipment according to still another embodiment of the invention can display a contents designated by the user earlier than other contents.

An on-vehicle equipment according to yet still another embodiment of the invention can display a designated contents in an enlarged fashion after presenting to audience an original layout of the contents so that even contents concealed by displaying the contents displayed in an enlarged fashion may be revealed to the user.

An on-vehicle equipment according to yet still another embodiment of the invention can prevent part of a contents to be so processed as to be displayed in an enlarged fashion from being concealed by user's finger.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a system configuration of an on-vehicle equipment 10 according to an embodiment of the present invention.

FIG. 2 is a block diagram showing an example of a functional configuration of a back end unit 30.

FIG. 3 is a conceptual diagram showing an example of a setting screen 40.

FIG. 4 is a table showing an example of structure of data stored in an enlargement information holding unit 307.

FIG. 5 is a table showing an example of structure of data stored in a display information holding unit 308.

FIG. 6 is a table showing an example of data structure of contents table 3090 stored in a contents information holding unit 309.

FIG. 7 is a table showing an example of structure of data stored in a drawing component holding unit 301.

FIG. 8 is a table showing an example of structure of data stored in a default layout holding unit 306.

FIGS. 9A and 9B are conceptual diagrams for explaining the membership of contents.

FIG. 10 is a table showing an example of structure of data stored in an enlarged layout holding unit 300.

FIGS. 11A and 11B are conceptual diagrams for explaining the behavior of displaying an enlarged contents.

FIG. 12 is a flowchart showing an example of operation of an on-vehicle equipment 10.

FIG. 13 is a flowchart continued from FIG. 12.

### DESCRIPTION OF THE EMBODIMENTS

The invention will now be described by way of example with reference to the accompanying drawings.

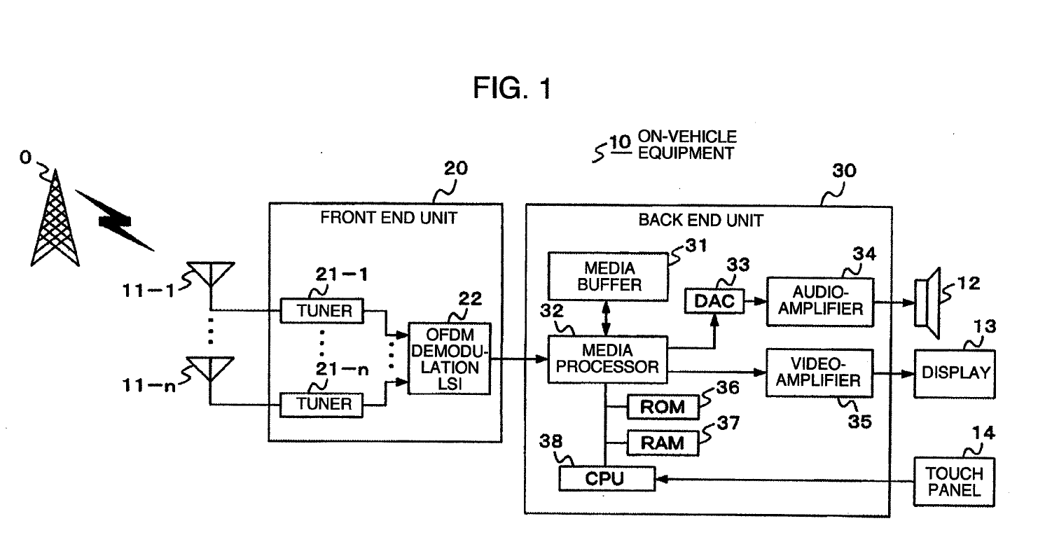

Referring to FIG. 1, an on-vehicle equipment 10 according to an embodiment of the invention is constructed as illustrated therein in a system configuration form.

The on-vehicle equipment 10 comprises a front end unit 20 and a back end unit 30. The front end unit 20 includes a plurality of tuners 21 and an OFDM (Orthogonal Frequency Division Multiplexing) demodulation LSI (Large Scale Integration circuit) 22.

Each tuner 21 demodulates a digital broadcasting electric wave transmitted from a relay station 0 and received by way of an antenna 11 and outputs the result of demodulation to the OFDM demodulation LSI 22. The OFDM LSI 22 synthesizes the demodulation results delivered out of the respective tuners 21-1 to 21-n through, for example, maximum ratio synthesis process and performs de-interleave and an error detection/correction process to restore a TS (Transport Stream) packet. Then, the OFDM demodulation LSI 22 outputs the thus restored TS packet to the back end unit 30.

The back end unit 30 includes a media buffer 31, a media processor 32, a DAC (Digital Analog Converter) 33, an audio-amplifier 34, a video-amplifier 35, a ROM (Read Only Memory) 36, a RAM (Random Access Memory) 37 and a CPU (Central Processing Unit) 38.

The media processor 32 receives the TS packet from the front end unit 20 and performs a process of demultiplexing the multiplexed image, audio signal and data broadcasting contents. Then, the media processor 32 decodes the demultiplexed image and stores temporarily a decoded result in the media buffer 31. Thereafter, the media processor 32 captures the decoded image data from the media buffer 31 at the timing of image output, the captured data being passed through the video amplifier 35 and displayed on a display 13.

The media processor 32 also decodes the demultiplexed audio signal and then stores temporarily a decoded result in the media buffer 31. Thereafter, the media processor 32 captures the decoded audio signal data from the media buffer 31 at the timing of audio signal output and the captured data, that is, a digital audio signal, is converted into an analog signal by means of the DAC 33 and outputted to a loudspeaker 12 via the audio-amplifier 34.

The ROM 36 stores programs before execution and fonts. The RAM 37 is a work area on which software operable in the back end unit 30 works. The CPU 38 controls commands necessary for the software to operate in the back end unit 30. The CPU 38 also operates, when the user touches a touch panel 14 provided on the screen of display 13, to calculate a coordinate corresponding to the user's touch on the screen.

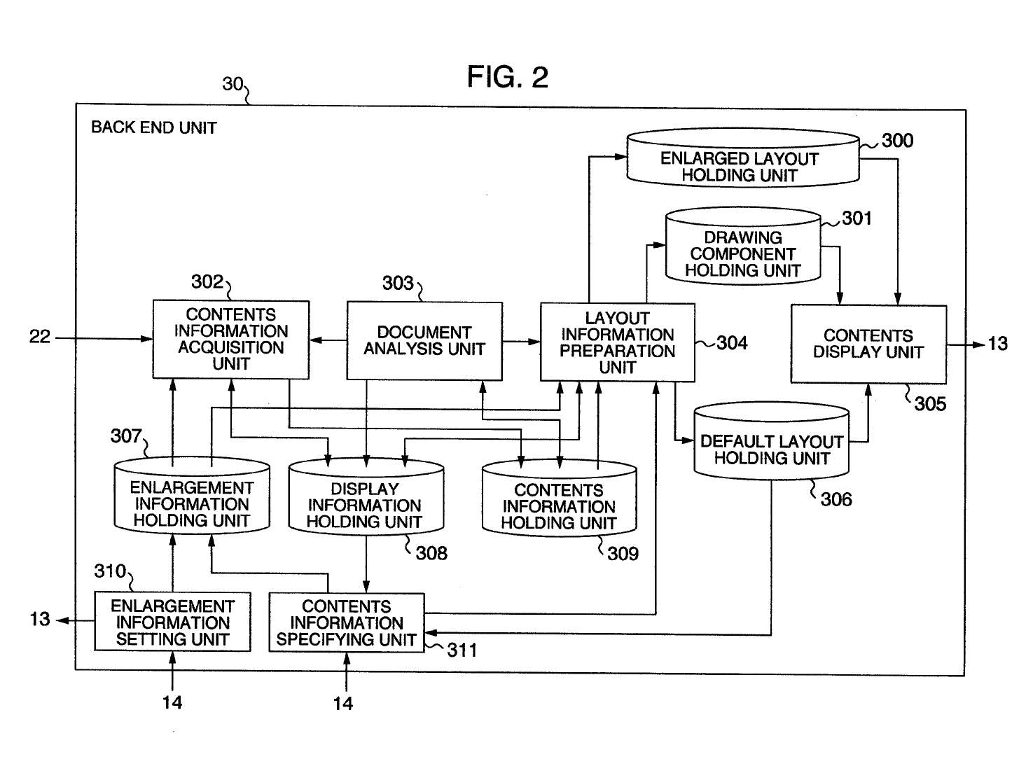

An example of functional configuration of the back end unit 30 is illustrated in block diagram form in FIG. 2. The back end unit 30 includes an enlarged layout holding unit 300, a drawing component holding unit 301, a contents information acquisition unit 302, a document analysis unit 303, a layout information preparation unit 304, a contents display unit 305, a default layout holding unit 306, an enlargement information holding unit 307, a display information holding unit 308, a contents information holding unit 309, an enlargement information setting unit 310 and a contents information specifying unit 311.

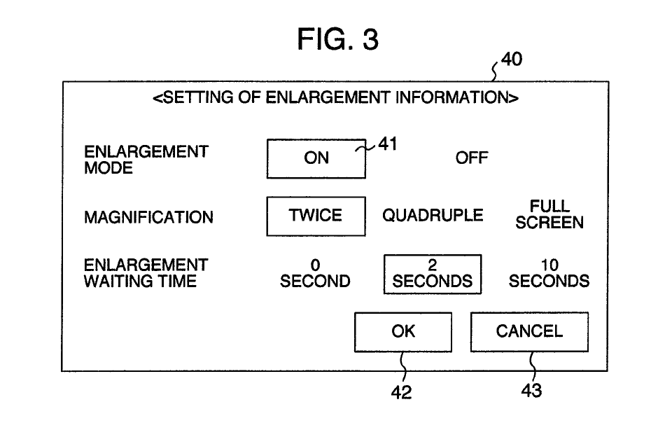

When setting of enlargement information is designated by the user through the touch panel 14, the enlargement information setting unit 310 operates to display a setting screen 40 as shown in FIG. 3, for example, on the display 13. Item “enlargement mode” is for establishing setting as to whether or not contents is enlarged automatically. Item “magnification” is for setting an enlargement ratio of contents which is designated by a ratio of the size of contents displayed on the screen after the enlargement to the size of contents displayed on the screen before enlargement. Item “renlargement response time” is for setting a period of time between the end of display of contents before enlargement and the start of display of contents after enlargement.

With OK button 42 selected in the setting screen 40, the enlargement information setting unit 310 stores in the enlargement information holding unit 307 set values at which cursors 41 are positioned in the respective items.

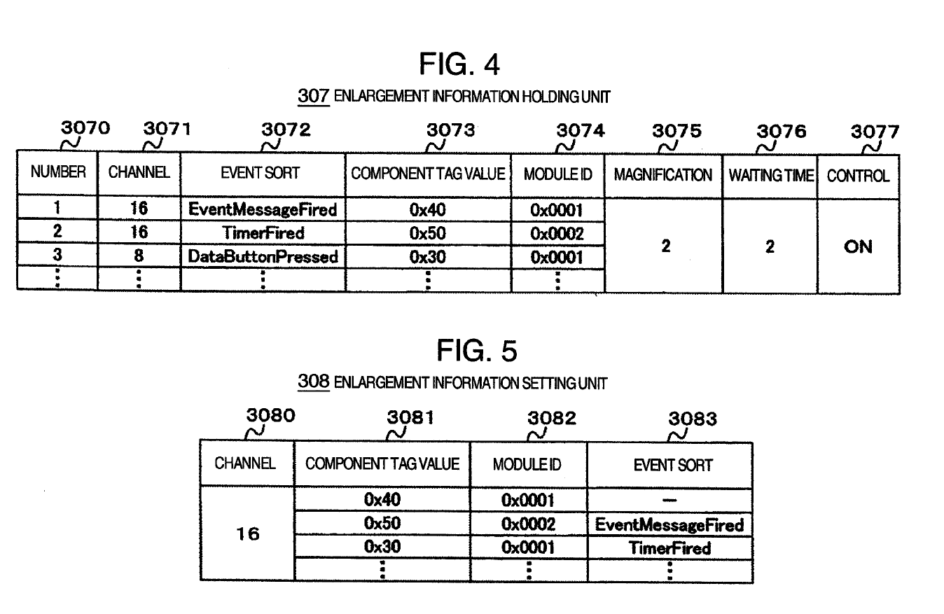

The enlargement information holing unit 307 has a data structure tabulated as shown in FIG. 4, for example, having columns of number 3070, channel 3071, event sort 3072, component tag value 3073, module ID 3074, magnification 3075, response time 3076 and control 3077 and entries are stored in respective cells in row in correspondence with respective entries in number 3070. Each module is specified by a combination of entries of component tag value 3073 and module ID 3074. The event sort 3072 indicates the sort of an event generated for a corresponding module immediately before it.

In the cell of control 3077, information indicative of ON is stored when contents is to be enlarged automatically and information indicative of OFF is stored when contents is not enlarged automatically. Information indicative of entries of magnification 3075, response time 3076 and control 3077 is set by the user through the enlargement information setting unit 310.

When receiving a TS packet from the front end unit 20, the contents information acquisition unit 302 extracts NIT (Network Information Table) and DSMCC (Digital Storage Media Command and Control) sections from the TS packet. Then, the contents information acquisition unit 302 takes out information indicative of a channel now in reception from the extracted NIT and stores it in the display information holding unit 308.

In the display information holding unit 308, as shown in FIG. 5, for example, a channel now in reception is entered in channel 3080 and information about a module containing a content to be displayed on the display 13 is stored. The module information has a combination of entries of component tag value 3081 and module ID 3082 for discriminating individual modules and an entry of event sort 3083 indicative of the sort of an event by means of which the module in question is caused to take the opportunity of being displayed in the present display form.

The contents information acquisition unit 302 takes out DDB (Download Data Block) and DII (Download Info Indication) from the extracted DSMCC section. Then, the contents information acquisition unit 302 generates a module from the DDB on the basis of module separation information contained in the DII. At that time, the contents information acquisition unit 302 preferentially generates, by consulting the enlargement information holding unit 307 and display information holding unit 308, a module corresponding to a combination of component tag value and module ID stored in the enlargement information holding unit 307 in correspondence with the channel now in reception.

Then, the contents information acquisition unit 302 extracts a file group of BML (Broadcast Markup Language) document, CSS (Cascading Style Sheets) document, contents of JPEG and PNG formats and an Ecma (European Computer Manufacturer Association) Script document and stores it in the contents information holding unit 309.

With the BML document stored in the contents information holding unit 309, the document analysis unit 303 prepares, from the BML document, a DOM (Document Object Model) Tree containing information necessary for layout of a data broadcasting screen and stores it in the contents information holding unit 309. When the Ecma Script document is stored in the contents information holding unit 309, the document analysis unit 303 captures the Ecma Script document from the contents information holding unit 309 and converts it into an executable object which in turn is arranged on the RAM.

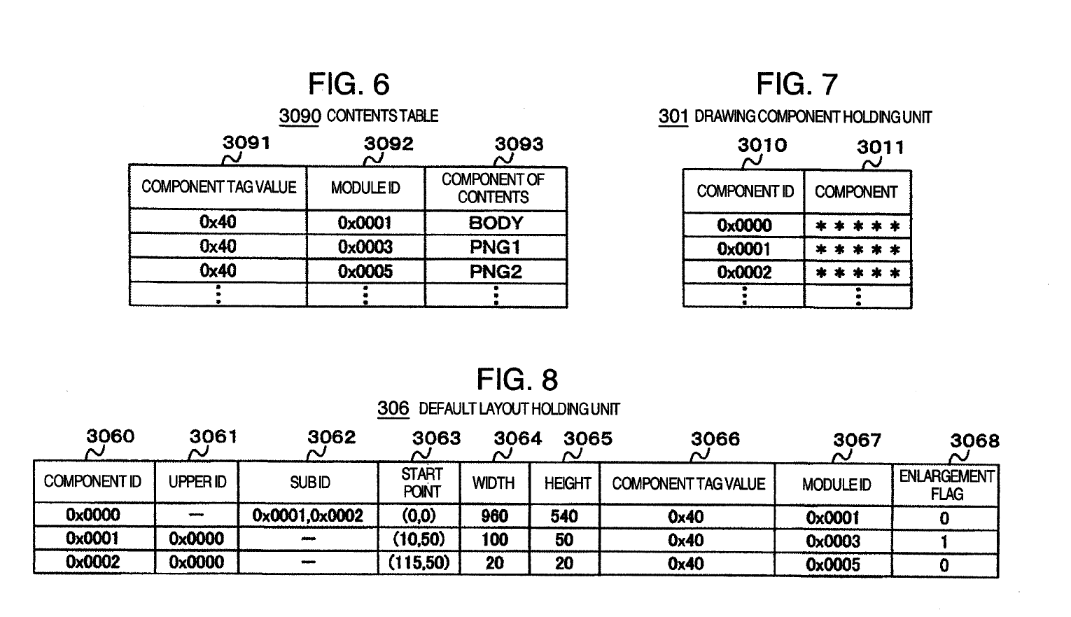

The document analysis unit 303 also captures from the contents information holding unit 309 a file containing the contents of JPEG and PNG formats and decodes the captured file so as to store it in the contents information holding unit 309. At that time, the document analysis unit 303 stores a contents table 3090 as shown in FIG. 6, for example, in the content information holding unit 309. In the contents table 3090, entries of component of contents 3093 included in the modules are stored in respect of individual combinations of entries of component tag value 3091 and module ID 3092 for discriminating the modules including contents.

When an event such as broadcasting event or key event is generated and a process described in the Ecma Script and corresponding to the event is executed, the document analysis unit 303 specifies, by consulting contents table 3090, a combination of component tag value and module ID of a module containing a contents which is changed in display through the above process and updates the sort of event, stored in the display information holding unit 308 in correspondence with the specified combination of component tag value and module ID, by using a sort of the generated event.

With the event generated, the document analysis unit 303 decides whether or not the module containing the contents to be displayed by the event has already been stored in the contents information holding unit 309. If the module containing the contents to be displayed by the generated event has already been stored in the contents information holding unit 309, the document analysis unit 303 instructs the layout information preparation unit 304 to change the layout on the basis of the result of process of Ecma Script corresponding to the event. On the other hand, if the module containing the contents to be displayed by the generated event is not stored in the contents information holding unit 309, the document analysis unit 303 instructs the contents information acquisition unit 302 to capture the module in question.

The layout information preparation unit 304 prepares layout information of defaults stipulated in data broadcasting by consulting the DOM Tree stored in the contents information holding unit 309. Then, the layout information preparation unit 304 acquires a contents to be displayed on the screen from the contents table 3090 inside the contents information holding unit 309 and reduces the acquired contents in size to that set in the prepared layout information of defaults, thus creating a drawing component. Then, the layout information preparation unit 304 stores, as shown in FIG. 7, for example, the created drawing component in the drawing component holding unit 301 in correspondence with a component ID discriminating the drawing component.

Incidentally, in data broadcasting, the layout is determined in advance and is assumed to be displayed on a display unit having a large screen the size of several tens of inches. Accordingly, the data broadcasting screen and each contents to be displayed in the prescribed layout on the display 13 of several inches connected to the on-vehicle equipment 10 according to the present embodiment are displayed in a reduced fashion as a whole.

Also, the layout information preparation unit 304 stores the layout information of the prepared defaults in the default layout holding unit 306 and besides, stores in the display information holding unit 308 not only the combination of component tag value and module ID of the module containing the contents to be displayed on the screen in accordance with the layout information but also the sort of an event by which the contents is caused to take the opportunity of being displayed.

The default layout holding unit 306 has a data structure tabulated as shown in FIG. 8, for example, having columns of component ID 3060 for discriminating drawing component, upper ID 3061 indicating an ID of a parent of the drawing component, sub ID 3062 indicating an ID of a child of the drawing component, start point 3063 indicating a start point coordinate on the screen at which the drawing component is displayed (in the present embodiment, an upper/left coordinate of a rectangular drawing component), width 3064 indicating the length of the drawing component in the horizontal direction of the screen, height 3065 indicating the length of the drawing component in the vertical direction of the screen, component tag value 3066 and module ID 3067 of a contents from which the drawing component originates and enlargement flag 3068 stored with 1 when the drawing component is an enlargement objective, and entries are given to respective cells in row in correspondence with respective entries in component ID 3060.

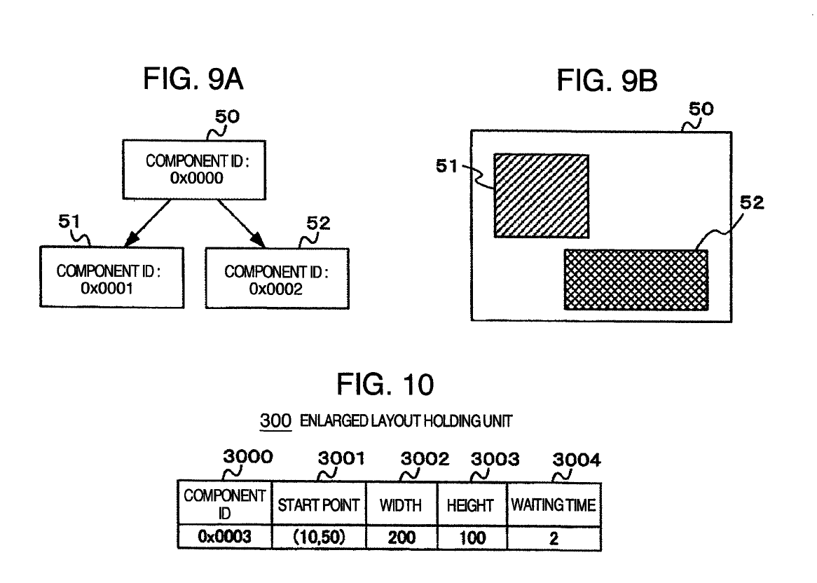

In the present embodiment, the entries of start point 3063, width 3064 and height 3065 are each designated by a numerical value in a unit of pixel. In a plurality of drawing components to be displayed on the screen of display 13, a membership of tree structure as shown in FIG. 9A, for example, is set. Drawing components in the membership as in FIG. 9A are displayed on the screen as shown in FIG. 9B, for example. A parent drawing component 50 is displayed on the backside of child drawing components 51 and 52.

Reverting to FIG. 2, a description will continue. The layout information preparation unit 304 decides by consulting a control flag inside the enlargement information holding unit 307 whether the function to automatically enlarge contents is effective. With the function to automatically enlarge contents rendered effective, the layout information preparation unit 304 decides, by consulting the enlargement information holding unit 307 and display information holding unit 308, whether a combination of channel, component tag value, module ID and event sort stored in the display information holding unit 308 is stored in the enlargement information holding unit 307.

If the combination is stored in the enlargement information holding unit 307, the layout information preparation unit 304 captures a contents corresponding to component tag value and module ID contained in the combination from the contents table 3090 inside the contents information holding unit 309 and acquires a magnification from the enlargement information holding unit 307. On the basis of the component tag value and module ID of the contents acquired from the contents table 3090, the layout information preparation unit 304 captures a size of default of the contents from the default layout holding unit 306.

Subsequently, the layout information preparation unit 304 processes the contents acquired from the contents table 3090 such that the contents has a size equaling the product of multiplying the default size acquired from the default layout holding unit 306 by the magnification acquired from the enlargement information holding unit 307, thus creating a drawing component after enlargement. Thereafter, the layout information preparation unit 304 prepares layout information concerning the enlarged drawing component and stores it in the enlarged layout holding unit 300.

The layout information concerning the enlarged drawing component is stored in the enlarged layout holding unit 300, as shown in FIG. 10, for example, having entries of component ID 3000 corresponding to the enlarged drawing component, start point 3001, width 3002 and height 3003 of the drawing component on the screen and response time 3004 indicative of a period of time (second in unit) between the end of display of a drawing component before enlargement on the screen and the start of display of the enlarged drawing component on the screen.

The layout information preparation unit 304 acquires information indicative of selection and besides, when receiving a selected coordinate on the screen, a component tag value and a module ID from the contents information specifying unit 311, acquires a contents corresponding to the component tag value and module ID from the contents table 3090 inside contents information preparation unit 309. Thereafter, the layout information preparation unit 304 captures a magnification from the enlargement information holding unit 307 and also captures from the default layout holding unit 306 a default size of the contents corresponding to the component tag value and module ID received from the contents information specifying unit 311.

Subsequently, the layout information preparation unit 304 processes the contents acquired from the contents table 3090 such that the contents has a size equaling the product of multiplying the default size acquired from the default layout holding unit 306 by the magnification acquired from the enlargement information holding unit 307, thus creating a drawing component after enlargement. Thereafter, the layout information preparation unit 304 stores the enlarged drawing component in the drawing component holding unit 301 in correspondence with the component ID and prepares layout information containing the component ID of the enlarged drawing component and stores it in the enlarged layout holding unit 300. Subsequently, the layout information preparation unit 304 instructs the contents display unit 305 to enlarge the drawing component.

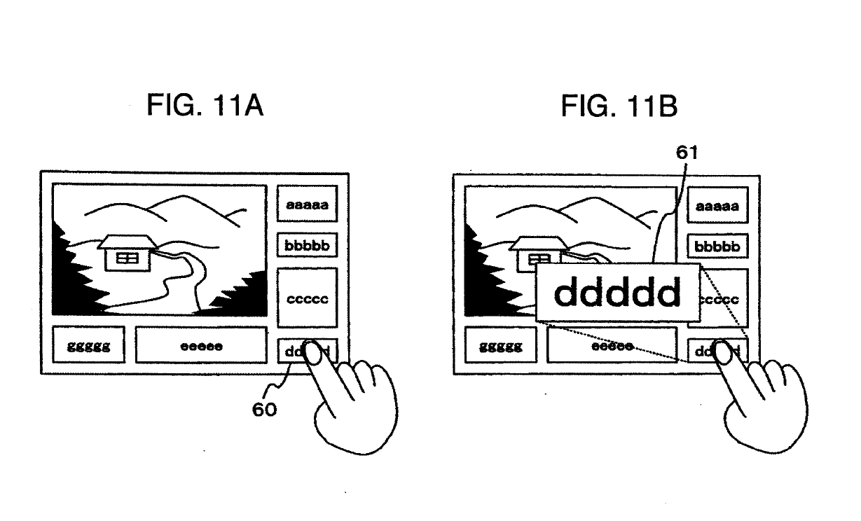

At that time, the layout information preparation unit 304 prepares layout information by which the enlarged drawing component can be displayed in an area on the screen excluding the coordinate received from the contents information specifying unit 311. Thus, when the user touches the screen to select a drawing component 60 displayed at a touched coordinate on the screen, as shown in FIG. 11A, for example, the layout information preparation unit 304 prepares a drawing component 61 as a result of enlargement of the drawing component 60 and besides, as shown in FIG. 11B, for example, prepares layout information by which the enlarged drawing component 61 can be arranged in an area on the screen excluding the coordinate the used has touched. In this manner, in the on-vehicle equipment 10, the enlarged drawing component 61 can be prevented from being partly concealed by the user's finger touching the screen to select the drawing component of enlargement objective.

Further, when receiving information indicative of selection release and besides a component tag value and a module ID from the contents information specifying unit 311, the layout information preparation unit 304 instructs the contents display unit 305 to release the enlargement of the drawing component. Then, the layout information preparation unit 304 deletes the drawing component of the same component ID as that registered in the enlarged layout holding unit 300 from the drawing component holding unit 301 and deletes data inside the enlarged layout holding unit 300.

In case layout information of defaults is stored in the default layout holding unit 306 or data inside the default layout holding unit 306 is updated, the contents display unit 305 follows the layout information of defaults to acquire a drawing component from the drawing component holding unit 301 and arrange it on the screen, causing a data broadcasting screen to be displayed on the display 13. Then, the contents display unit 305 decides by consulting an enlargement flag inside default layout holding unit 306 whether a drawing component for which “1” is stored in the enlargement flag, that is, a drawing component of enlargement objective is present.

In the presence of the drawing component of enlargement objective, the contents display unit 305 consults the enlarged layout holding unit 300 to acquire a drawing component indicated by the layout information after enlargement from the drawing component holding unit 301 and after a response time stored in the enlarged layout holding unit 300 has elapsed, displays the acquired drawing component on the screen of display 13 in accordance with the layout information after enlargement. The contents display unit 305 writes individual drawing component into a VRAM (Video RAM) in layout of defaults, for instance, and after lapse of the response time, overwrites the enlarged drawing component on the VRAM in accordance with the layout information after enlargement.

Further, when being instructed by the layout information preparation unit 304 to enlarge drawing component, the contents display unit 305 extracts a component ID contained in the layout information after enlargement by consulting the enlargement layout information holding unit 300. Then, the contents display unit 305 acquires from the drawing component holding unit 301 a drawing component corresponding to the extracted component ID and displays the acquired drawing component on the screen of display 13 in accordance with the layout information inside the enlarged layout holding unit 300.

When being instructed by the layout information preparation unit 304 to release selection, the contents display unit 305 returns a data broadcasting screen to be displayed on the display 13 to a structure conforming to layout information of defaults inside default layout holding unit 306.

When the user touches the touch panel 14 on the screen of display 13, the contents information specifying unit 311 specifies a coordinate on the screen the user has touched and decides whether the user has performed an operation meaning “selection” or an operation meaning “determination”. The operation meaning “selection” is for keeping the same coordinate on the screen touched for a predetermined time (for example, one second) or more, for instance, and the operation meaning “determination” is for touching twice consecutively the same coordinate on the screen within a predetermined time (for example, one second) as in the case of double click, for instance.

When the user carries out the operation meaning “selection”, the contents information specifying unit 311 extracts, by consulting the default layout holding unit 306, a combination of component tag value and module ID of a contents corresponding to a drawing component displayed most frontally at the coordinate on the screen touched by the user and transmits, together with the extracted combination, information indicative of selection and the selected coordinate on the screen as well to the layout information preparation unit 304.

When the user carries out the operation meaning “selection release”, the contents information specifying unit 311 transmits to the layout information preparation unit 304 the information indicative of selection release along with the combination of component tag value and module ID of the contents corresponding to the drawing component now being selected. The operation meaning “selection release” is for keeping the touch panel 14 on the screen of display 13 untouched by anything for one second or more after completion of the operation meaning “selection”.

When the user carries out the operation meaning “determination”, the contents information specifying unit 311 extracts, by consulting the default layout holding unit 306, a combination of component tag value and module ID of the contents corresponding to the drawing component displayed most frontally at the coordinate the user has touched.

Then, the contents information specifying unit 311 specifies an event sort corresponding to the extracted combination of component tag value and module ID by consulting the display information holding unit 308. By also consulting the display information holding unit 308, the contents information specifying unit 311 specifies a channel now in reception. The contents information specifying unit 311 then stores in the enlargement information holding unit 307 the specified event sort and the channel in correspondence with the extracted combination of component tag value and module ID.

In this manner, the contents corresponding to the drawing components designated through the operation “determination” by the user can be captured preferentially by the contents information acquisition unit 302 and displayed automatically in enlarged size by means of the contents display unit 305. Further, with the user's operation meaning “determination” applied to the drawing components of enlargement objective contents, information concerning the enlargement objective contents is registered automatically in the enlargement information holding unit 307, so that labor and time consumed by the user to input text information and the like for specifying the contents of enlargement display can be reduced.

With the operation meaning “determination” executed by the user, the contents information specifying unit 311 does not transmit the information indicative of “selection release” to the layout information preparation unit 304. This ensures that when a drawing component of enlargement display objective is determined by user's selection operation in the course of one by one enlargement display of drawing component, the data broadcasting screen can be watched without interruption while keeping the drawing component of enlargement display objective displayed in enlarged size.

In the present embodiment, the user performs the operation for selection or determination of contents through the medium of the touch panel 14 but the invention is in no way limited thereto and the selection operation may be executed by moving the cursor key through the use of a remote controller or the determination operation may be executed by means of a determination key of remote controller.

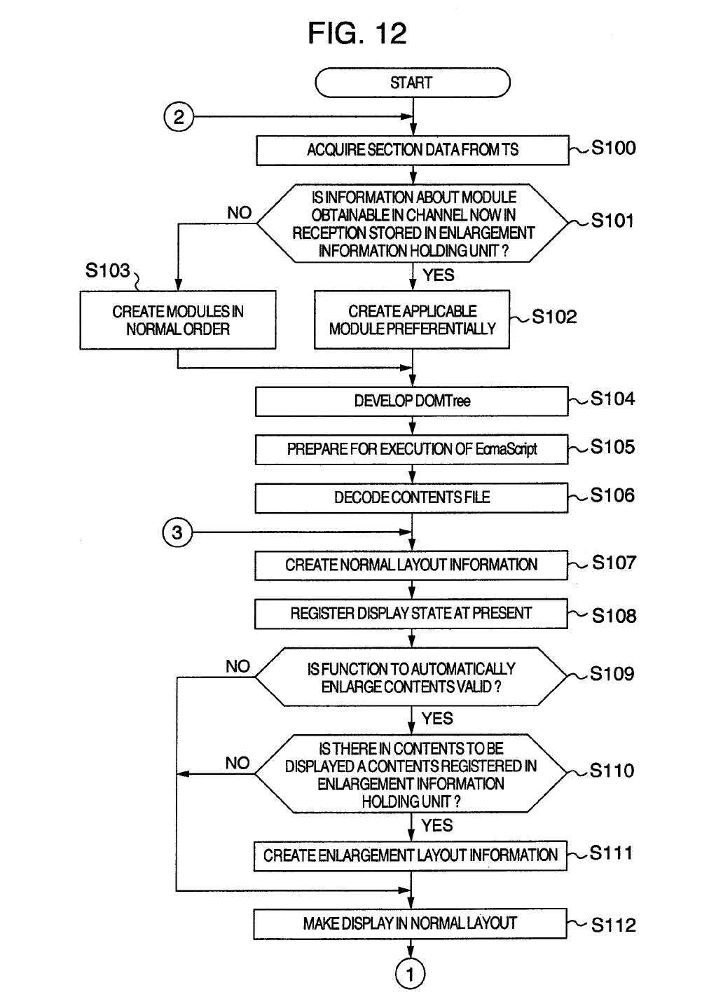

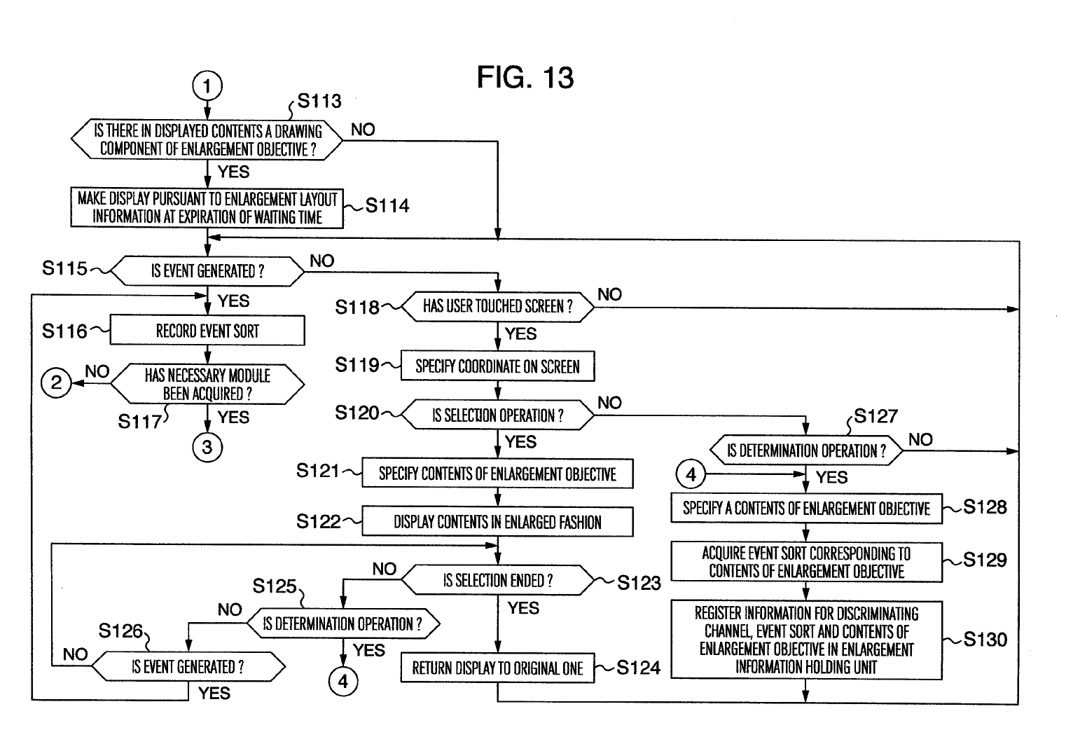

Turning now to FIGS. 12 and 13, there is illustrated a flowchart showing an example of operation of the on-vehicle equipment 10. For example, at predetermined timing of starting display of data broadcasting designated by the user, the on-vehicle equipment 10 starts operation shown in this flow chart.

Firstly, the front end unit 20 demodulates a digital broadcasting electric wave received via the antenna 11, synthesizes results of demodulation, restores a TS packet by performing de-interleave and a process of error detection/correction and delivers the decoded TS packet to the back end unit 30. Then, the contents information acquisition unit 302 inside back end unit 30 extracts NIT and DSMCC sections from the TS packet (S100).

Subsequently, the contents information acquisition unit 302 extracts from the NIT information indicative of a channel now in reception and stores it in the display information holding unit 308. Then, the contents information acquisition unit 302 extracts DDB and DII from the extracted DSMCC section. Thereafter, on the basis of module separation information contained in the DII, the contents information acquisition unit 302 specifies a combination of component tag value and module ID of an obtainable module.

Subsequently, the contents information acquisition unit 302 determines whether the specified combination of component tag value and module ID is stored in the enlargement information holding unit 307 in correspondence with the channel being received at present (S101). If the specified combination of component tag value and module ID is not stored in the enlargement information holding unit 307 in correspondence with the channel now in reception (S101: No), the contents information acquisition unit 302 creates modules in order prescribed by, for example, the contents creator (S103) and executes a process shown in step S104.

On the other hand, if the specified combination of component tag value and module ID is stored in the enlargement information holding unit 307 in correspondence with the channel now in reception (S101: Yes), the contents information acquisition unit 302 preferentially creates a module corresponding to the specified combination of component tag value and module ID (S102). In this phase, the contents information acquisition unit 302 creates other modules than the module corresponding to the specified combination of component tag value and module ID in order prescribed by, for example, the contents creator.

Next, the contents information acquisition unit 302 extracts a file group contained in the created module, including BML document, CSS document, contents in JPEG and PNG formats and Ecma Script document and stores the file group in the contents information holding unit 309. And, the document analysis unit 303 prepares a DOMTree from the BML document and stores it in the contents information holding unit 309 (S104).

Next, the document analysis unit 303 acquires the Ecma Script document stored in the contents information holding unit 309 and converts it into an executable object which in turn is arranged on the RAM (S105). Then, the document analysis unit 303 acquires from the contents information holding unit 309 a file containing contents in JPEG and PNG formants, decodes it and stores the decoding result in the contents table 3090 in correspondence with a combination of component tag value and module ID for discriminating a module containing the contents (S106).

Subsequently, the layout information preparation unit 304 prepares layout information of defaults stipulated in data broadcasting by consulting the DOMTree stored in the contents information holding unit 309 (S107). Then, the layout information preparation unit 304 acquires from the contents table 3090 a contents to be displayed on the screen, creates a drawing component by reducing the acquired contents to a size set in the layout information of prepared defaults and stores a created drawing component in the drawing component holding unit 301 in correspondence with the part ID of the drawing component.

Next, the layout information preparation unit 304 stores the layout information of prepared defaults in the default layout holding unit 306 and besides, stores in accordance with the layout information not only a combination of component tag value and module ID of the module containing the contents to be displayed on the screen in accordance with the layout information but also a sort of an event by which the contents is caused to take the opportunity of being displayed in the display information holding unit 308 (S108).

Next, the layout information preparation unit 304 decides by consulting a control flag inside the enlargement information holding unit 307 whether the function to automatically enlarge contents is effective (S109). If the function to automatically enlarge contents is ineffective (S109: No), the layout information preparation unit 304 executes a process shown in step S112.

On the other hand, when the function to automatically enlarge contents is effective (S109: Yes), the layout information preparation unit 304 decides by consulting the enlargement information holding unit 307 and display information holding unit 308 whether a combination of channel, component tag value, module ID and event sort stored in the display information holding unit 308 is stored in the enlargement information holding unit 307 (S110). If the combination of channel, component tag value, module ID and event sort stored in the display information holding unit 308 is not stored in the enlargement information holding unit 307 (S110: No), the layout information preparation unit 304 executes a process shown in step S112.

On the other hand, when the combination of channel, component tag value, module ID and event sort stored in the display information holding unit 308 is stored in the enlargement information holding unit 307 (S110: Yes), the layout information preparation unit 304 acquires a contents corresponding to the component tag value and module ID contained in the combination from the contents table 3090 inside the contents information holding unit 309 and besides, acquires a magnification from the enlargement information holding unit 307. Then, on the basis of the component tag value and module ID of the contents acquired from the contents table 3090, the layout information preparation unit 304 acquires a size of defaults of the contents from the default layout holding unit 306.

Next, the layout information preparation unit 304 processes the contents acquired from the contents table 3090 such that the contents has a size equaling the product of multiplying the default size acquired from the default layout holding unit 306 by the magnification acquired from the enlargement information holding unit 307, creating a drawing component after enlargement and stores the thus created drawing component after enlargement in the drawing component holding unit 301 in correspondence with the component ID. Then, the layout information preparation unit 304 prepares layout information concerning the enlarged drawing component and stores it in the enlargement layout holding unit 300 (S111).

Next, the contents display unit 305 follows the layout information stored in the default layout holding unit 306 to acquire a drawing component from the drawing component holding unit 301 and arrange it on the screen, thus displaying a data broadcasting screen on the display 13 (S 112). Subsequently, the contents display unit 305 decides by consulting an enlargement flag inside default layout holding unit 306 whether or not a drawing component for which “1” is stored in the enlargement flag, that is, a drawing component of enlargement objective is present (S113 in FIG. 13).

In the absence of any drawing components of enlargement objective inside the default layout holding unit 306 (S11: No), the contents display unit 305 executes a process shown in step S115. On the other hand, in the presence of a drawing component of enlargement objective inside the default layout holding unit 306 (S113: Yes), the contents display unit 305 acquires, by consulting the enlargement layout holding unit 300, a drawing component indicated in layout information after enlargement from the drawing part holding unit 301 and after a response time stored in the enlargement layout holding unit 300 has elapsed, displays the acquired drawing component on the screen of display 13 in accordance with the layout information after enlargement (S114).

Next, the document analysis unit 303 decides whether such an event as broadcasting event or key event is generated (S115). With the event generated (S115: Yes), the document analysis unit 303 consults the contents table 3090, after a process described in the Ecma Script and corresponding to the event has been executed, so as to specify a combination of component tag value and module ID of a module containing a contents which is changed in display form through the process as above. Then, the documents analysis unit 303 updates the event sort stored in the display information holding unit 308 in correspondence with the specified combination of component tag value and module ID by using a sort of the generated event (S116).

Next, the document analysis unit 303 decides whether or not the module containing the contents to be displayed by the generated event has already been stored in the contents information holding unit 309 (S117). If the module containing the contents to be displayed by the generated event has already been stored in the contents information holding unit 309 (S117: Yes), the document analysis unit 303 instructs, on the basis of the result of the Ecma Script corresponding to the event, the layout information preparation unit 304 to change the layout and the layout information preparation unit 304 again executes the process shown in step S107 (see FIG. 12).

On the other hand, if the module containing the contents to be displayed by the generated event is not stored in the contents information holding unit 309 (S117: No), the document analysis unit 303 instructs the contents information acquisition unit 302 to capture the module. Then, the contents information acquisition unit 302 again executes the process shown in step S100 (see FIG. 12).

If no event is generated in the step S115 (S115: No), the contents information specifying unit 311 decides whether the user touches the touch panel 14 on the screen of display 13 (S118). With the touch panel 14 on the screen of display 13 not touched by the user (S118: No), the document analysis unit 303 again executes the process shown in the step S115.

On the other hand, with the touch panel 14 on the screen of display 13 touched by the user (S118: Yes), the contents information specifying unit 311 specifies a coordinate on the screen the user has touched (S119) and makes a decision as to whether the operation meaning “selection” is present (S120).

When the user conducts the operation meaning “selection” (S120: Yes), the contents information specifying unit 311 specifies, by consulting the default layout holding unit 306, a combination of component tag value and module ID of a drawing component displayed most frontally at the coordinate on the screen the user has touched and transmits to the layout information preparation unit 304 the specified combination together with information indicative of selection and information indicative of the coordinate touched by the user (S121).

Subsequently, the layout information preparation unit 304 acquires from the contents table 3090 inside contents information holding unit 309 a contents corresponding to the component tag value and module ID received from the contents information specifying unit 311 and a magnification from the enlargement information holding unit 307 and acquires a size of default of the contents corresponding to the component tag value and module ID received from the contents information specifying unit 311 from the default layout holding unit 306.

Next, the layout information preparation unit 304 processes the contents acquired from the contents table 3090 such that the contents has a size equaling the product of multiplying the default size acquired from the default layout holding unit 306 by the magnification acquired from the enlargement information holding unit 307, thus creating a drawing component after enlargement and stores the enlarged drawing component in the drawing component holding unit 301 in correspondence with the component ID. Then, the layout information preparation unit 304 prepares layout information containing the component ID of the enlarged drawing component, stores it in the enlargement layout holding unit 300 and instructs the contents display unit 305 to enlarge the drawing component.

Next, by consulting the enlargement layout holding unit 300, the contents display unit 305 extracts a component ID contained in the layout information after enlargement and acquires a drawing component corresponding to the extracted component ID from the drawing component holding unit 301. Then, the contents display unit 305 displays on the screen of display 13 the acquired drawing component in accordance with the layout information inside the enlargement layout holding unit 300 (S122).

Thereafter, the contents information specifying unit 311 decides whether the selection operation by the user has ended by making a decision as to whether the user's finger leaves the touch panel 14 on the screen of display 13 (S123). With the user's selection operation ended (S123: Yes), the contents information specifying unit 311 sends to the layout information preparation unit 304 information indicative of selection release together with the combination of component tag value and module ID of the contents corresponding to the drawing component in selection.

The layout information preparation unit 304 instructs the contents display unit 305 to release enlargement of the drawing component. Then, the layout information preparation unit 304 deletes from the drawing component holding unit 301 the drawing component of the same component ID as that registered in the enlargement layout holding unit 300 and also, data inside the enlargement layout holding unit 300. The contents display unit 305 returns a data broadcasting screen to be displayed on the display 13 to the structure pursuant to layout information of default inside the default layout holding unit 306 (S124) and the document analysis unit 303 again executes the process shown in the step S115.

If the user's selection operation has not been ended (S123: No), the contents information specifying unit 311 decides whether the user has conducted the operation meaning “determination” (S125). With the user's operation meaning “determination” conducted (S125: Yes), the contents information specifying unit 311 executes a process shown in step 128.

If the user has not conducted the operation meaning “determination” (S125: No), the document analysis unit 303 decides whether an event such as broadcasting event or key event is generated (S126). With an event generated (S126: Yes), the document analysis unit 303 executes the process shown in the step S116. On the other hand, with any event not generated (S126: No), the contents information specifying unit 311 again executes the process shown in the step 123.

If, in the step S120, the user has not conducted the operation meaning “selection” (S120: No), the contents information specifying unit 311 decides whether the user has conducted the operation meaning “determination” (S127). With the operation meaning “determination” not conducted by the user (S127: No), the document analysis unit 303 again executes the process shown in the step 115.

If the user has conducted the operation meaning “determination” (S127: Yes), the contents information specifying unit 311 extracts, by consulting the default layout holding unit 306, a combination of component tag value and module ID of a drawing component displayed most frontally at a coordinate on the screen touched by the user, in other words, information for specifying contents (S128).

Next, by consulting the display information holding unit 308, the contents information specifying unit 311 acquires a channel now in reception and an event sort corresponding to the extracted combination of component tag value and module ID (S129). Then, the contents information specifying unit 311 stores in the enlargement information holding unit 307 the acquired event sort and channel in correspondence with the extracted combination of component tag value and module ID (S130) and the document analysis unit 303 again executes the process shown in the step S115.

The embodiments of the present invention have been described.

As is clear from the foregoing description, the on-vehicle equipment 10 according to this invention can display more easily visibly the contents in data broadcasting without affecting the data transmission band of data broadcasting.

The present invention is in no way limited to the foregoing embodiments but can be modified, altered or changed without departing from the gist of the invention.

For example, in the present embodiment, the on-vehicle equipment is assumed as an example of built-in apparatus but the invention is not limited thereto and can also be applied to such a built-in apparatus as a portable information terminal or notebook sized personal computer capable of receiving and displaying data broadcastings in digital broadcasting.

While in the foregoing embodiment the data broadcasting in digital broadcasting which is on the air by using 13 segments is assumed but the invention is not limited thereto and is also applicable to so-called one-segment data broadcasting which is on the air by using one segment.

In some kinds of contents, when a character string displayed on the right side of the screen (an area in which contents name is displayed) is selected, this selection will sometimes trigger information displayed in a different area on the screen in association with the character string to cause this information to be updated but if the character string on the right side of the screen is selected in such a case, not the character string but the information updated through the selection of the character string may be displayed in an enlarged fashion.

In a specific operation to this effect, the contents information specifying unit 311 specifies in the step S121 in FIG. 13, for example, by consulting the default layout holding unit 306, a combination of component tag value and module ID of a drawing component displayed most frontally at a coordinate on the screen the user has touched and sends to the layout information preparation unit 304 the specified combination together with information indicative of selection and information indicative of the coordinate on the screen touched by the user (S121).

The layout information preparation unit 304 holds in advance a correlation table which correlates a combination of component tag value and module ID of a drawing component displayed on the right side with a combination of component tag value and module ID of a different drawing component which changes in display under triggering of selection of the drawing component displayed on the right side. When receiving the combination of component tag value and module ID of the drawing component from the contents information specifying unit 311, the layout information preparation unit 304 decides whether the combination of component tag value of module ID of the different drawing component which changes in display in association with the drawing component responsible for triggering is present in the correlation table.

When there exits the combination of component tag value and module ID of the different drawing component which changes in display in association with the drawing component received from the contents information specifying unit 311, the layout information preparation unit 304 acquires from the contents table 3090 inside contents information holding unit 309 a contents corresponding to the component tag value and module ID of the different drawing component, acquires a magnification from the enlargement information holding unit 307 and a size of default of the contents corresponding to the component tag value and module ID of the different drawing components from the default layout holding unit 306. Thereafter, processes in the steps ensuing step S122 are executed by using the different drawing component as a drawing component of enlargement objective.

It should be further understood by those skilled in the art that although the foregoing description has been made on embodiments of the invention, the invention is not limited thereto and various changes and modifications may be made without departing from the spirit of the invention and the scope of the appended claims.

1. An on-vehicle equipment mounted on a vehicle and adapted to receive a data broadcasting transmitted in digital broadcasting and display it on a display unit, comprising:
contents information holding means for holding a contents of the data broadcasting in correspondence with a combination of component tag value and module ID for discriminating the contents;
contents information acquisition means for acquiring a contents transmitted in data broadcasting and for storing in said contents information holding means the acquired contents together with a corresponding combination of component tag value and module ID;
layout information preparation means for preparing, in respect of individual combinations of component tag values and module ID's for discriminating the individual contents, layout information of defaults containing information indicative of areas on the screen of said display unit at which the contents are displayed;
contents display means for acquiring, in accordance with the layout information of defaults, a corresponding contents from said contents information holding means and displaying it on the screen of said display unit; and
contents information specifying means for specifying, by consulting the layout information of defaults, a combination of component tag value and module ID corresponding to a contents displayed at a coordinate on the screen of display unit designated by the user and transmitting the specified combination of component tag value and module ID to said contents display means,
wherein when receiving a combination of component tag value and module ID from said contents information specifying means, said contents display means acquires, by consulting said contents information holding means, a contents corresponding to the combination of component tag value and module ID and displays the acquired contents on the screen of said display unit in a size larger than that for display pursuant to the layout information of defaults.

2. The on-vehicle equipment according to claim 1 further comprising enlargement information holding means for holding a combination of component tag value and module ID of a contents to be displayed in an enlarged fashion,
wherein said contents information specifying means further specifies, by consulting the default layout information when the user conducts a predetermined operation on the screen of said display unit, a combination of component tag value and module ID corresponding to a contents displayed at a coordinate on the screen of display unit designated by the user and stores the specified combination of component tag value and module ID in said enlargement information holding means; and
said contents display means further displays on the screen of said display unit the contents corresponding to the combination of component tag value and module ID stored in said enlargement information holding means in a size larger than that for display when the combination of component tag value and module ID corresponding to the contents is not stored in said enlargement information holding means.

3. The on-vehicle equipment according to claim 2 further comprising:
display information holding means for holding, in respect of individual combinations of component tag values and module ID's of contents displayed on the screen of said display unit, event information indicative of the sort of an event by which a contents is caused to have the opportunity of being displayed; and
event recording means for storing, each time that an event takes place, event information of the event in said display information holding means in correspondence with a combination of component tag value and module ID of a contents which is caused by the event to have the opportunity of being changed in display form,
wherein said contents information specifying means further specifies, by consulting the default layout information when the user conducts a predetermined operation on the screen of said display unit, a combination of component tag value and module ID corresponding to a contents displayed at a coordinate on the screen of display unit designated by the user, extracts, by consulting said display information holding means, event information corresponding to the specified combination of component tag value and module ID and stores the specified combination of component tag value and module ID and the extracted event information in said enlargement information holding means; and
said contents display means displays on the screen of said display unit the contents corresponding to the combination of component tag value and module ID stored in said enlargement information holding means in a size larger than that for display when the combination of component tag value and module ID corresponding to the contents and of event information is not stored in said enlargement information holding means.

4. The on-vehicle equipment according to claim 2, wherein said contents information acquisition means preferentially acquires a contents corresponding to a combination of component tag value and module ID stored in said enlargement information holding means and stores it in said contents information holding means, and said contents display means displays the contents on the screen of said display unit in order of subsequent storage of contents in said contents information holding means.

5. The on-vehicle equipment according to claim 2, wherein said enlargement information holding means further holds a response time between the end of display of a contents in normal size and the start of display of the contents in larger size, and said contents display means displays on the screen of said display unit a contents corresponding to a combination of component tag value and module ID stored in said enlargement information holding means in the same size as that for display when the combination of component tag value and module ID is not stored in said enlargement information holding means and displays, at the termination of the response time stored in said enlargement information holding means, the contents in an enlargement fashion.

6. The on-vehicle equipment according to claim 1, wherein when displaying the contents corresponding to the combination of component tag value and module ID specified by said contents information specifying means, said contents display means displays said contents at an area on the screen excluding the coordinate designated by the user.
